(19) United States
(12) Patent Application Publication
(10) Pub. No.: US 2002/0120660 A1
(43) Pub. Date: Aug. 29, 2002

(54) Method and apparatus for associating virtual server identifiers with processes

(76) Inventors: Russell C. Hay, Kirkland, WA (US); Erik J. Anderson, North Bend, WA (US); Ryan Kraay, Redmond, WA (US)

Correspondence Address: PARK, VAUGHAN & FLEMING LLP, 508 SECOND STREET, SUITE 201, DAVIS, CA, 95616, US

(21) Appl. No.: 09/795,873

(22) Filed: Feb. 28, 2001

(51) Int. Cl. G06F 15/163; G06F 9/00; G06F 15/16; G06F 9/54

(52) U.S. Cl. 709/100; 709/310; 709/106

(57) ABSTRACT

One embodiment of the present invention provides a mechanism that associates a virtual server identifier with a process in an operating system, wherein the operating system supports multiple virtual servers running within multiple virtual environments. Upon receiving a call to an operating system function from the process, the system looks up an identifier for a virtual server associated with the process. If the identifier exists, the system uses the identifier in performing the operating system function, so that the operating system function accesses only objects defined within a virtual environment associated with the virtual server, and does not access objects defined outside the virtual environment In one embodiment of the present invention, the system receives a command to initialize a new process. If the new process is being initialized within a target virtual environment associated with a target virtual server, the system assigns an identifier for the target virtual server to the new process.

### RELATED APPLICATION

The subject matter of this application is related to the subject matter in a co-pending non-provisional application by the same inventor as the instant application and filed on the same day as the instant application entitled, “Method and Apparatus for Controlling Access to Files Associated With a Virtual Server,” having serial number TO BE ASSIGNED, and filing date TO BE ASSIGNED (Attorney Docket No. M00-273200).

### BACKGROUND

1. Field of the Invention

The present invention relates to operating systems for computers. More specifically, the present invention relates to a method and an apparatus for associating virtual servers identifiers with processes within an operating system, wherein the operating system supports multiple virtual servers on a single computing platform.

2. Related Art

Application service providers (ASPs) are commonly used to support numerous applications for multiple enterprises, partners and end users. Within an ASP, applications belonging to different enterprises are often run on the same computing platform in order to reduce deployment costs. However, this consolidation can create problems, because processes belonging to one enterprise can potentially access information belonging to another enterprise.

This problem can be remedied by running applications belonging to different enterprises on different “virtual servers” that operate within different “virtual environments” on the same computer system. In this type of system, processes running on a first virtual server in a first virtual environment are insulated from processes running on a second virtual server in a second virtual environment. This means that processes operating within a given virtual environment are only able to access entities or resources defined within the given virtual environment. Hence, from a user's perspective the given virtual environment appears to be a stand-alone computer system that is dedicated to the given virtual environment.

Existing operating system structures are not well-suited to facilitate virtual servers and virtual environments. The UNIX FREEBSD™ operating system presently supports a chroot( ) command that changes the root directory for a process, and thereby forces the process to run on a subset of the file system, without being able to access any other parts of the file system.

However, existing operating systems presently lack other mechanisms to efficiently support virtual environments. For example, there is presently no efficient mechanism to kill processes belonging to a specific virtual server, because processes are presently defined independently of virtual servers. There is also presently no efficient mechanism to enforce resource constraints on a given virtual server to ensure that a process executing on the given virtual server is only able to access system resources that are allocated to the given virtual server.

What is needed is a method and an apparatus for efficiently managing virtual servers and associated virtual environments within a computer system.

### SUMMARY

One embodiment of the present invention provides a mechanism that associates a virtual server identifier with a process in an operating system, wherein the operating system supports multiple virtual servers running within multiple virtual environments. Upon receiving a call to an operating system function from the process, the system looks up an identifier for a virtual server associated with the process. If the identifier exists, the system uses the identifier in performing the operating system function, so that the operating system function accesses only objects defined within a virtual environment associated with the virtual server, and does not access objects defined outside the virtual environment.

In one embodiment of the present invention, the system looks up the identifier for the virtual server by examining a field for the virtual server identifier within a process structure maintained by the operating system.

In one embodiment of the present invention, using the identifier involves using the identifier to restrict access by the process to only those system resources that are associated with the virtual server.

In one embodiment of the present invention, the operating system function can include: a function to kill processes associated with the virtual server; a function to allocate file space from a pool of file space allocated to the virtual server; or a function to allocate memory space from a pool of memory space associated with the virtual server.

In one embodiment of the present invention, the system receives a command to initialize a new process. If the new process is being initialized within a target virtual environment associated with a target virtual server, the system assigns an identifier for the target virtual server to the new process. This facilitates restricting the new process so that the new process only accesses objects defined within the target virtual environment, and does not access objects defined outside the target virtual environment.

In a variation on the above embodiment, the system assigns a new virtual server identifier to the new process if the target virtual server is a new virtual server. If the target virtual server is not a new virtual server, the system assigns an existing virtual server identifier to the new process.

In a variation on the above embodiment, the system assigns the existing virtual server identifier to the new process by copying the identifier for the target virtual server from a parent process, if the new process is being spawned by the parent process within the target virtual environment. Otherwise, the system looks up the identifier for the target virtual server, and then assigns the identifier to the new process.

In a variation on the above embodiment, the multiple virtual environments supported by the operating system are implemented through jails defined within the FreeBSD operating system.

In a variation on the above embodiment, if an identifier for a virtual server is not associated with the process, the system performs the operating system function without regard to virtual servers.

### BRIEF DESCRIPTION OF THE FIGURES

FIG. 1 illustrates a computer system in accordance with an embodiment of the present invention.

FIG. 2 illustrates data structures involved in facilitating virtual servers and virtual environments in accordance with an embodiment of the present invention.

FIG. 3 is a flow chart illustrating the initialization of a process in accordance with an embodiment of the present invention.

FIG. 4 is a flow chart illustrating the use of a virtual server identifier within a system call in accordance with an embodiment of the present invention.

FIG. 5 is a flow chart illustrating how a process kill function for a virtual server operates in accordance with an embodiment of the present invention.

FIG. 6 is a flow chart illustrating how resources are allocated to a process operating within a virtual environment in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

Computer System

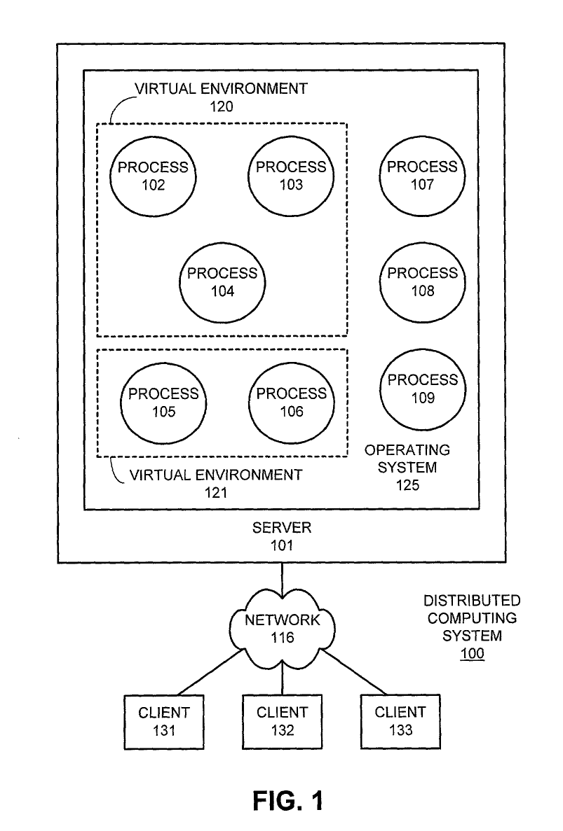

FIG. 1 illustrates a distributed computing system 100 in accordance with an embodiment of the present invention. Distributed computing system 100 includes server 101, which is coupled to clients 131-133 through network 130.

Network 130 can generally include any type of wire or wireless communication channel capable of coupling together computing nodes. This includes, but is not limited to, a local area network, a wide area network, or a combination of networks. In one embodiment of the present invention, network 130 includes the Internet.

Clients 131-133 and server 101 are computer systems, which can generally include any type of computer system, including, but not limited to, a computer system based on a microprocessor, a mainframe computer, a digital signal processor, a portable computing device, a personal organizer, a device controller, and a computational engine within an appliance.

More specifically, clients 131-133 can generally include any node on a network including computational capability and including a mechanism for communicating across network 130. Server 101 can generally include any computational node including a mechanism for servicing requests from a client for computational and/or data storage resources.

Server 101 contains an operating system 125, which supports a number of processes 102-109. Some of these processes 102-109 operate inside virtual environments 120-121. In particular, processes 102-104 operate inside virtual environment 120, and processes 105-106 operate inside virtual environment 121. Other processes, such as processes 107-109, do not operate within the confines of a virtual environment.

Note that processes 102-104, which operate inside virtual environment 120, are only able to access entities, such as the other processes, defined within virtual environment 120, and are only able to access resources allocated to virtual environment 120, such as file space and memory space. Similarly, processes 105-106 are only able to access entities and resources defined within virtual environment 121. These restrictions ensure that processes 102-104 are insulted from other resources and from entities within operating system 125 that exist inside other virtual environments, or that exist outside of other virtual environments.

Note each virtual environment 120 and 121 is associated with its own virtual server (not shown). (The terms “virtual server” and “virtual environment” are used somewhat interchangeably throughout this specification.)

Furthermore, note that virtual environments 120-121 can be used to host multiple servers within a single server 101. For example, virtual environment 120 can be used to host a first web site for a first enterprise, while virtual environment 121 can be used to host a second web site for a second enterprise. In this way, the first web site and the second web site can run concurrently on the same underlying server 101, without interfering with each other. Hence, by using the present invention, a single computing device can potentially host hundreds or even thousands of virtual environments at the same time.

Also note that each virtual environment 120 and 121 appears to be operating on a separate dedicated computer system, whereas in reality, virtual environments 120 and 121 operate on the same computer system.

Data Structures

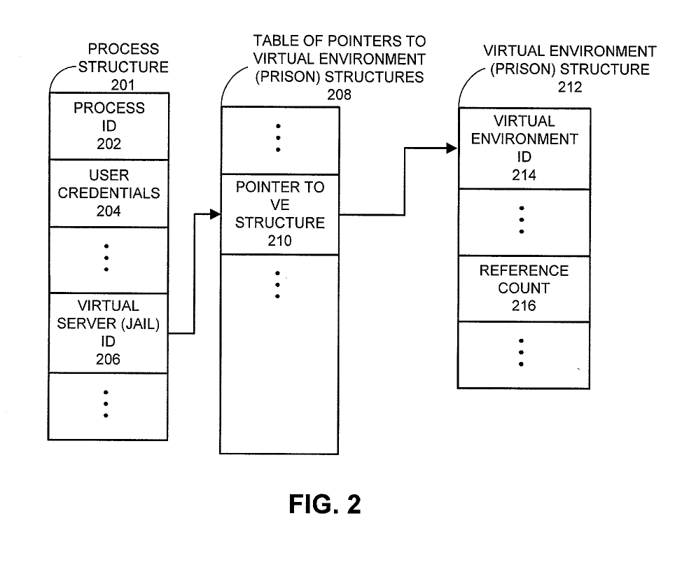

FIG. 2 illustrates data structures involved in facilitating virtual servers and virtual environments in accordance with an embodiment of the present invention. Each of the processes 102-109 within FIG. 1 has its own process data structure within operating system 125. FIG. 2 illustrates an example process data structure 201, which contains a number of items associated within a process, such as process ID 202, which uniquely identifies the process and user credentials 204 that identify powers of a user of the process.

In order to facilitate virtual servers, process data structure 201 additionally includes a virtual server ID field 206, which contains an identifier for the virtual server to which the process belongs. If virtual server ID field 206 contains a NULL or invalid value, the associated process does not belong to a virtual server. In one embodiment of the present invention, virtual server ID field 206 contains a “jail ID” that identifies a “jail” defined within the UNIX FreeBSD operating system. Note that no prior operating system provides such a virtual server ID, which is stored within a process structure.

The virtual server ID within field 206 can be used to index a table of pointers to virtual environment structures 208. (Note that a virtual environment is sometimes referred to as a prison.) Each non-NULL entry in table 208 points to a virtual environment structure, such as virtual environment structure 212.

Virtual environment structure 212 generally contains information that defines an associated virtual environment. This can include a virtual environment ID 214, as well as a reference count 216. Reference count 216 indicates the number of active processes that are presently operating within an associated virtual environment. Hence, reference count 216 is incremented every time a new process is created within the associated virtual environment, and reference count 216 is decremented every time a process is removed from the associated virtual environment.

Process Initialization

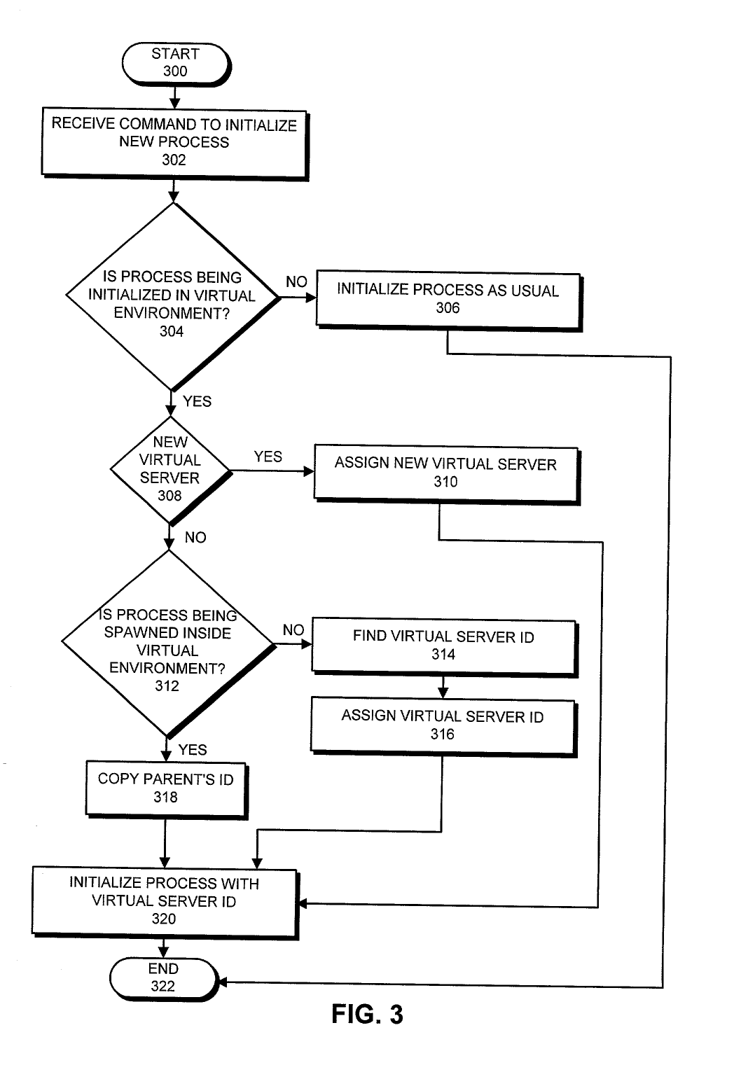

FIG. 3 is a flow chart illustrating the initialization of a process in accordance with an embodiment of the present invention. The system starts by receiving a call to an operating system function to initialize a process (box 302). The system first determines if the process is being initialized within a virtual environment (box 304). In embodiment of the present invention, this involves examining an argument to the process initialization function to see if a virtual environment is identified. If the process is not being initialized within a virtual environment, the system initializes the process as usual (box 306).

Otherwise, if the process is being initialized within a virtual environment, the system determines whether the associated virtual server is a new virtual server (box 308). This may involve scanning through table 208 in FIG. 2 looking for the virtual server. If the virtual server is a new virtual server, the system assigns a new virtual server identifier to the process (box 310), and then initializes the process with the virtual server ID (box 320). In one embodiment of the present invention, this involves copying the virtual server ID into field 206 within process data structure 201 in FIG. 2.

If at box 308 the virtual server is not a new virtual server, the system determines if the process is being spawned inside a virtual environment (box 312). If so, the system copies a virtual server identifier from a parent process (box 318) in order to initialize the process (box 320).

If at box 312 the process is not being spawned within a virtual environment, the system finds the virtual server ID (box 314). In one embodiment of the present invention, this involves performing a lookup based upon factors such as an Internet Protocol (IP) address of the virtual server to find the virtual server ID. Next, the system assigns the virtual server ID to the process (box 316), and then initializes the process (box 320).

Use of Virtual Server Identifier

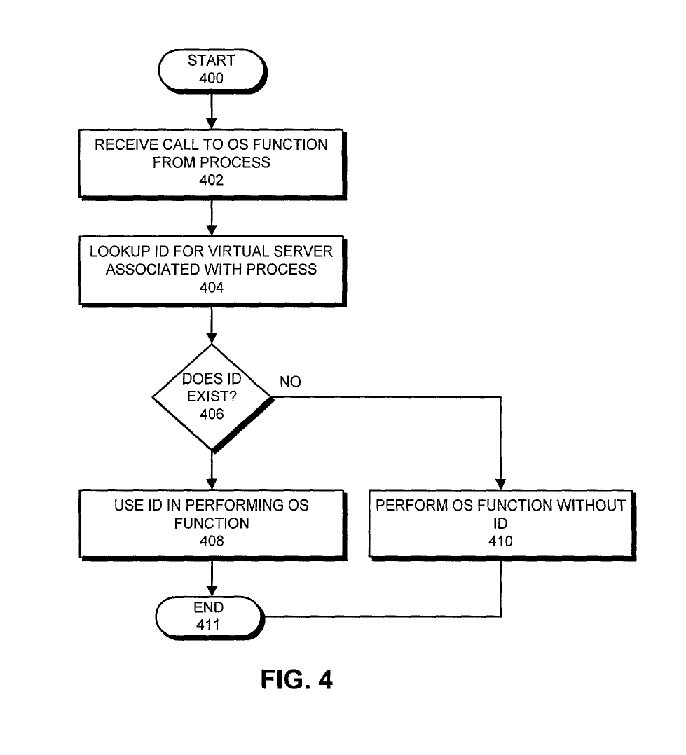

FIG. 4 is a flow chart illustrating the use of a virtual server identifier within a system call in accordance with an embodiment of the present invention. The system starts by receiving an operating system call from a process (box 402). Next, the system looks up an identifier for a virtual server associated with the process (box 404). This may involve examining field 206 within process data structure 201 in FIG. 2. If a virtual server identifier exists, the system uses the virtual server identifier in performing the operating system function (box 408). Otherwise, the system performs the operating system function without using the virtual server identifier (box 410). For example, a process kill function with a virtual server identifier can only kill processes within an associated virtual environment, whereas a process kill function without a virtual server identifier can potentially kill any process within the operating system.

Process Kill Function

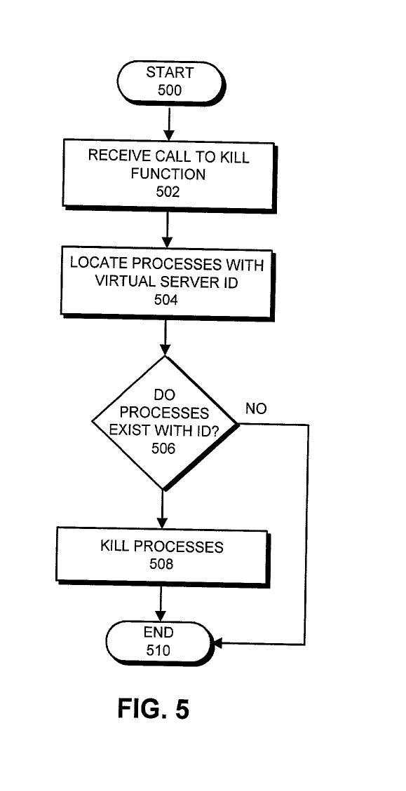

FIG. 5 is a flow chart illustrating how a process kill function for a virtual server operates in accordance with an embodiment of the present invention. At box 408 of FIG. 4, the system receives a call to a process kill function with an associated virtual server ID (box 502). The system next locates processes with the virtual server ID (box 504). In one embodiment of the present invention, this is accomplished by examining the “/proc” directory in the UNIX operating system. If such processes are located, they are killed (box 508). Otherwise, the virtual server has no processes. Hence, the system call simply terminates.

Resource Allocation

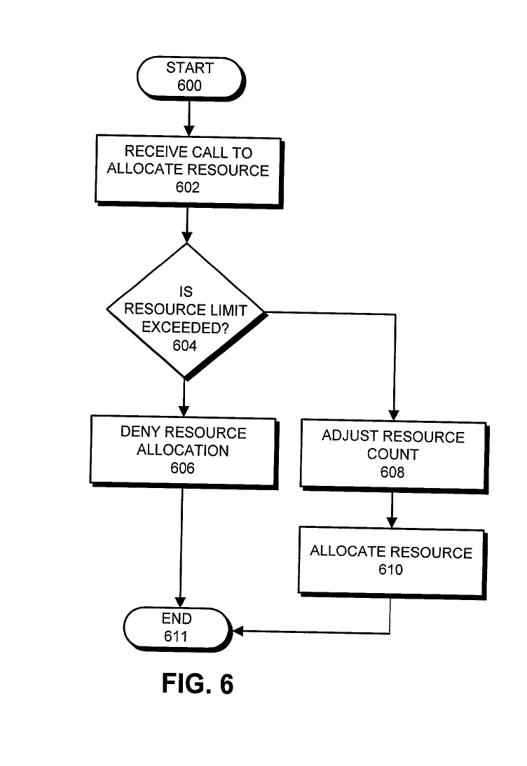

FIG. 6 is a flow chart illustrating how resources are allocated to a process operating within a virtual environment in accordance with an embodiment of the present invention. At box 408 of FIG. 4, the system receives a call to a function that allocates a resource (such as a file or memory space) with an associated virtual server identifier (box 602). The system next determines whether a resource limit for the associated virtual environment will be exceeded by the allocation (box 604). In one embodiment of the present invention, this is accomplished by examining resource allocation parameters within the virtual environment structure 212 associated with the virtual environment. If a resource limit will be exceeded by the allocation, the system denies the allocation (box 606). Otherwise, if the resource limit will not be exceeded, the system adjusts the remaining resource count (box 608), and then allocates the requested resource to the process (box 610).

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for facilitating an association of a virtual server identifier with a process in an operating system, wherein the operating system supports multiple virtual servers operating within multiple virtual environments, the method comprising:
receiving a call to an operating system function from the process;
looking up an identifier for a virtual server associated with the process;
if the identifier for the virtual server exists, using the identifier in performing the operating system function, so that the operating system function accesses only objects defined within a virtual environment associated with the virtual server, and does not access objects defined outside the virtual environment.

2. The method of claim 1, wherein looking up the identifier for the virtual server involves examining a field for the virtual server identifier within a process structure maintained by the operating system.

3. The method of claim 1, wherein using the identifier involves using the identifier to restrict access by the process to only those system resources that are associated with the virtual server.

4. The method of claim 1, wherein the operating system function includes one of:
a function to kill processes associated with the virtual server;
a function to allocate file space from a pool of file space allocated to the virtual server; and
a function to allocate memory space from a pool of memory space associated with the virtual server.

5. The method of claim 1, further comprising initializing a new process in the operating system by:
receiving a command to initialize the new process; and
if the new process is being initialized within a target virtual environment associated with a target virtual server, assigning an identifier for the target virtual server to the new process, so that the new process accesses only objects defined within the target virtual environment, and does not access objects defined outside the target virtual environment.

6. The method of claim 5, wherein assigning the identifier involves:
assigning a new virtual server identifier to the new process if the target virtual server is a new virtual server; and
if the target virtual server is not a new virtual server, assigning an existing virtual server identifier to the new process.

7. The method of claim 6, wherein assigning the existing virtual server identifier to the new process involves:
copying the identifier for the target virtual server from a parent process if the new process is being spawned by the parent process within the target virtual environment; and
if the new process is not being spawned within a virtual environment,
looking up the identifier for the target virtual server, and
assigning the identifier to the new process.

8. The method of claim 1, wherein the multiple virtual environments supported by the operating system are implemented through jails defined within the FreeBSD operating system.

9. The method of claim 1, wherein if an identifier for a virtual server is not associated with the process, the method further comprises performing the operating system function without regard to virtual servers.

10. A computer-readable storage medium storing instructions that when executed by a computer cause the computer to perform a method for facilitating an association of a virtual server identifier with a process in an operating system, wherein the operating system supports multiple virtual servers operating within multiple virtual environments, the method comprising:
receiving a call to an operating system function from the process;
looking up an identifier for a virtual server associated with the process;
if the identifier for the virtual server exists, using the identifier in performing the operating system function, so that the operating system function accesses only objects defined within a virtual environment associated with the virtual server, and does not access objects defined outside the virtual environment.

11. The computer-readable storage medium of claim 10, wherein looking up the identifier for the virtual server involves examining a field for the virtual server identifier within a process structure maintained by the operating system.

12. The computer-readable storage medium of claim 10, wherein using the identifier involves using the identifier to restrict access by the process to only those system resources that are associated with the virtual server.

13. The computer-readable storage medium of claim 10, wherein the operating system function includes one of:
a function to kill processes associated with the virtual server;
a function to allocate file space from a pool of file space allocated to the virtual server; and
a function to allocate memory space from a pool of memory space associated with the virtual server.

14. The computer-readable storage medium of claim 10, wherein the method further comprises initializing a new process in the operating system by:
receiving a command to initialize the new process; and
if the new process is being initialized within a target virtual environment associated with a target virtual server, assigning an identifier for the target virtual server to the new process, so that the new process accesses only objects defined within the target virtual environment, and does not access objects defined outside the target virtual environment.

15. The computer-readable storage medium of claim 14, wherein assigning the identifier involves:
assigning a new virtual server identifier to the new process if the target virtual server is a new virtual server; and
if the target virtual server is not a new virtual server, assigning an existing virtual server identifier to the new process.

16. The computer-readable storage medium of claim 15, wherein assigning the existing virtual server identifier to the new process involves:
copying the identifier for the target virtual server from a parent process if the new process is being spawned by the parent process within the target virtual environment; and
if the new process is not being spawned within a virtual environment,
looking up the identifier for the target virtual server, and
assigning the identifier to the new process.

17. The computer-readable storage medium of claim 10, wherein the multiple virtual environments supported by the operating system are implemented through jails defined within the FreeBSD operating system.

18. The computer-readable storage medium of claim 10, wherein if an identifier for a virtual server is not associated with the process, the method further comprises performing the operating system function without regard to virtual servers.

19. An apparatus that facilitates associating a virtual server identifier with a process in an operating system, wherein the operating system supports multiple virtual servers operating within multiple virtual environments, the apparatus comprising:
a system call processing mechanism that is configured to receive a call to an operating system function from the process;
a lookup mechanism that is configured to look up an identifier for a virtual server associated with the process;
wherein if the identifier for the virtual server exists, the system call processing mechanism is configured to use the identifier in performing the operating system function, so that the operating system function accesses only objects defined within a virtual environment associated with the virtual server, and does not access objects defined outside the virtual environment.

20. The apparatus of claim 19, wherein the lookup mechanism is configured to look up a field for the virtual server identifier within a process structure maintained by the operating system.

21. The apparatus of claim 19, wherein the system call processing mechanism is configured to use the identifier to restrict access by the process to only those system resources that are associated with the virtual server.

22. The apparatus of claim 19, wherein the operating system function includes one of:
a function to kill processes associated with the virtual server;
a function to allocate file space from a pool of file space allocated to the virtual server; and
a function to allocate memory space from a pool of memory space associated with the virtual server.

23. The apparatus of claim 19, further comprising a process initialization mechanism that is configured to:
receive a command to initialize a new process; and to
assign an identifier for a target virtual server to the new process, if the new process is being initialized within a target virtual environment associated with a target virtual server, so that the new process accesses only objects defined within the target virtual environment, and does not access objects defined outside the target virtual environment.

24. The apparatus of claim 23, wherein the process initialization mechanism is configured to:
assign a new virtual server identifier to the new process if the target virtual server is a new virtual server; and to
assign an existing virtual server identifier to the new process if the target virtual server is not a new virtual server.

25. The apparatus of claim 24, wherein in assigning the existing virtual server identifier the new process, the process initialization mechanism is configured to:
copy the identifier for the target virtual server from a parent process if the new process is being spawned by the parent process within the target virtual environment; and to
look up the identifier for the target virtual server, and to assign the identifier to the new process, if the new process is not being spawned within a virtual environment.

26. The apparatus of claim 19, wherein the multiple virtual environments supported by the operating system are implemented through jails defined within the FreeBSD operating system.

27. The apparatus of claim 19, wherein if an identifier for a virtual server is not associated with the process, the system call processing mechanism is configured to perform the operating system function without regard to virtual server identifiers.
